(19) United States
(12) Patent Application Publication
(10) Pub. No.: US 2026/0172517 A1
(43) Pub. Date: Jun. 18, 2026

(54) INFORMATION PROCESSING APPARATUS, DISPLAY CONTROL METHOD, AND STORAGE MEDIUM

(71) Applicant: CANON KABUSHIKI KAISHA, Tokyo (JP)

(72) Inventor: SHUNSUKE MAKI, Tokyo (JP)

(21) Appl. No.: 19/414,504

(22) Filed: Dec. 10, 2025

(30) Foreign Application Priority Data
Dec. 16, 2024 (JP) 2024-220269

(51) Int. Cl. H04N 1/00; G06F 9/451

(52) U.S. Cl. CPC H04N 1/00962; G06F 9/453

(57) ABSTRACT

An information processing apparatus capable of communicating with a reading apparatus has: a processing unit configured to periodically perform obtainment processing to obtain first information from the reading apparatus, the first information indicating whether an operation to instruct scanning has been performed on the reading apparatus; a setting unit configured to enable or disable a particular function allowing the information processing apparatus to obtain a scan result from the reading apparatus, the particular function being based on the operation performed on the reading apparatus to instruct scanning; and a display control unit configured to perform control to display at least one of a first guidance and a second guidance, the first guidance pertaining to periodical execution of the obtainment processing by the processing unit in a case where the setting unit enables the particular function and the second guidance pertaining to disabling the particular function.

### BACKGROUND

### Field of the Technology

The present disclosure relates to an information processing apparatus, a display control method, and a storage medium.

### Description of the Related Art

There are systems in which a device such as a personal computer or a smartphone (also referred to as an “information terminal”) obtains and saves an image acquired by a scanner or the like (also referred to as a reading apparatus) by scanning an original. In such a system, the information terminal obtains the scanned image by communicating with and controlling the reading apparatus.

Also, as a way for the information terminal to communicate with and control the reading apparatus, the information terminal may poll the reading apparatus. Specifically, polling is a method by which the information terminal communicates with and controls the reading apparatus by transmitting an inquiry request packet periodically to the reading apparatus.

A push scan service is an example of functions that an information terminal can implement by polling a reading apparatus. A push scan service here performs the following. Specifically, a scan instruction is issued by an operation performed on the reading apparatus end, and the information terminals detects the scan instruction for the reading apparatus by polling and then instructs the reading apparatus to start scanning. As thus instructed, the reading apparatus scans an original. The information terminal obtains scan data acquired by the scanning from the reading apparatus. In a case of communicating with the reading apparatus over a network, the information terminal uses an Internet Protocol (IP) address as the address of the communication destination. In a case where the information terminal cannot communicate with the reading apparatus, there is a possibility that the IP address of the reading apparatus has been changed. Thus, the information terminal may employ a method that searches for the reading apparatus using broadcast or multicast. Japanese Patent Laid-Open No. 2015-82767 discloses a technique for avoiding a situation where an information terminal keeps performing polling even though there is no reading apparatus to be polled in the communication environment for the information terminal, causing unnecessary network traffic or performing unnecessary processing. In this technique, the information terminal is configured to determine the information terminal's communication environment, and in a case where the information terminal is in a communication environment different from a communication environment for polling the reading apparatus, stop polling the reading apparatus to avoid unnecessary polling processing.

In the technique disposed in Japanese Patent Laid-Open No. 2015-82767, the information terminal determines the information terminal's communication environment and stops polling the reading apparatus in a case where the information terminal is in a communication environment different from a communication environment for polling the reading apparatus. However, the information terminal performs polling in a case where the information terminal is in the same communication environment as the communication environment for polling the reading apparatus. Also, in a case where the information terminal searches for the reading apparatus using broadcast or multicast because the information terminal cannot communicate with the reading apparatus, the information terminal may transmit packets to a plurality of devices existing in the information terminal's communication environment. Depending on the device or protocol, the device outputs a log of warning, error, or the like upon receipt of an unexpected packet. For instance, in the event where a switch or server receives a Simple Network Management Protocol (SNMP) packet transmitted from the information terminal, the following situation occurs. Specifically, depending on a tool in the switch or server, the switch or server outputs a warning log in a case where the received packet is an SNMP packet with an unauthorized community name. Also, a user may be unaware of the fact that the information terminal is performing polling communications for the push scan service. This leads to a problem where the user does not understand what is causing the switch or server to periodically output the warning log.

### SUMMARY

In view of the above points, the present disclosure aims to make it easier for a user to understand a polling setting for a push scan service and to change the polling setting.

In an aspect of the present disclosure, there is provided a n information processing apparatus capable of communicating with a reading apparatus, the information processing apparatus comprising at least one memory and at least one processor which function as: a processing unit configured to periodically perform obtainment processing to obtain first information from the reading apparatus, the first information indicating whether an operation to instruct execution of scanning has been performed on the reading apparatus; a setting unit configured to set to enable or disable a particular function that allows the information processing apparatus to obtain, from the reading apparatus, a scan result acquired by the reading apparatus by the execution of the scanning, the particular function being based on the operation performed on the reading apparatus to instruct execution of scanning; and a display control unit configured to perform control to display at least one of a first guidance and a second guidance, the first guidance pertaining to periodical execution of the obtainment processing by the processing unit in a case where the setting unit enables the particular function and the second guidance pertaining to disabling the particular function.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an example configuration of a system including an information terminal, a reading apparatus, and a server;

FIG. 2 is a block diagram showing an example hardware configuration of the information terminal;

FIG. 3 is a block diagram showing an example hardware configuration of the reading apparatus;

FIG. 4 is a diagram showing the relationship of FIGS. 4A and 4B;

FIG. 4A is a flowchart showing an example of push scan processing by the information terminal;

FIG. 4B is a flowchart showing an example of push scan processing by the information terminal;

FIG. 5A is a schematic diagrams showing example user interfaces on the information terminal;

FIG. 5B is a schematic diagram showing example user interfaces on the information terminal;

FIG. 5C is a schematic diagram showing example user interfaces on the information terminal;

FIG. 6 is a flowchart showing an example of push scan processing by the reading apparatus;

FIG. 7 is a schematic diagram showing example user interfaces on the reading apparatus; and

FIG. 8 is a schematic diagram showing another example user interface on the information terminal.

### DESCRIPTION OF THE EMBODIMENTS

Embodiments are described in detail below with reference to the accompanying drawings. Note that the embodiments below do not limit the present disclosure according to the scope of claims. Although a plurality of features are described in the embodiments, not all the features are necessarily essential for the present disclosure, and the plurality of features may be combined as needed. Also, in the accompanying drawings, the same or like configurations are denoted by the same reference numeral and may not be described repetitively.

### First Embodiment

### <<System Configuration>>

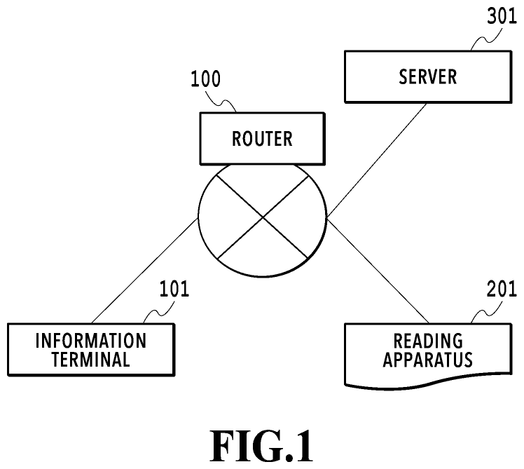

FIG. 1 is a diagram showing an example configuration of a system including an information terminal 101, a reading apparatus 201, and a server 301 in the present embodiment.

The information terminal 101, the reading apparatus 201, and the server 301 are connected via a router 100 and can communicate with devices on the same network.

The information terminal 101, which is, for example, a personal computer or a smartphone, is connected to the router 100 and can communicate with devices on the same network and the Internet. Note that the connection between the information terminal 101 and the router 100 may be a wireless LAN or a wired LAN.

The reading apparatus 201 is, for example, an image formation apparatus with a scanner function and generates scan image data by optically reading an image on an original set on a flatbed or an automatic document feeder (ADF) (not shown). Also, the reading apparatus 201 is connected to the router 100 and can communicate with devices on the same network and the Internet. The connection between the reading apparatus 201 and the router 100 may be a wireless LAN or a wired LAN. Note that the information terminal 101 and the reading apparatus 201 may communicate not through the router 100, but through a Universal Serial Bus (USB) connection using the USB.

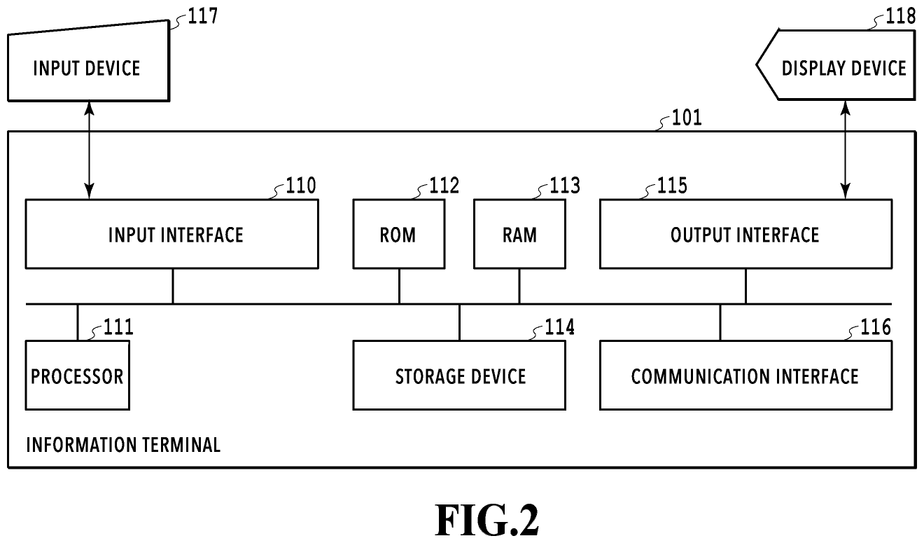

FIG. 2 is a block diagram showing an example hardware configuration of the information terminal 101 of the present embodiment.

The information terminal 101 is an example of the information processing apparatus of the present embodiment and has an input interface 110, a processor 111 such as a CPU, ROM 112, RAM 113, a storage device 114, an output interface 115, and a communication interface 116. The ROM 112 is a type of computer-readable storage medium. Note that an input device 117 is connected to the input interface 110, and a display device 118 is connected to the output interface 115. An initialization program is stored in the ROM 112, and a group of application programs, an operating system (OS), and other various kinds of data are stored in the storage device 114. The RAM 113 is used as, e.g., workspace memory in execution of the various programs stored in the storage device 114. The communication interface 116 communicates with the reading apparatus 201 and the server 301 via the network. Note that the communication interface 116 transmits and receives data to and from devices on the same network and the Internet via a wireless LAN or a wired LAN using a protocol such as TCP/IP. The display device 118 is configured including a liquid crystal display and a graphics controller and displays objects such as images and icons and graphical user interfaces (GUIs) to a user. The input device 117 is a device for receiving operations for various instructions to the information terminal 101 from the user and is a mouse, a keyboard, or the like. Note that the input device 117 may be integrated with the display device 118 and configured as a touch panel.

The information terminal 101 receives a scan instruction from the reading apparatus 201 through the communication interface 116. After that, the information terminal 101 transmits a scan start instruction to the reading apparatus 201, causes the reading apparatus 201 to scan an original, and receives scan data from the reading apparatus 201.

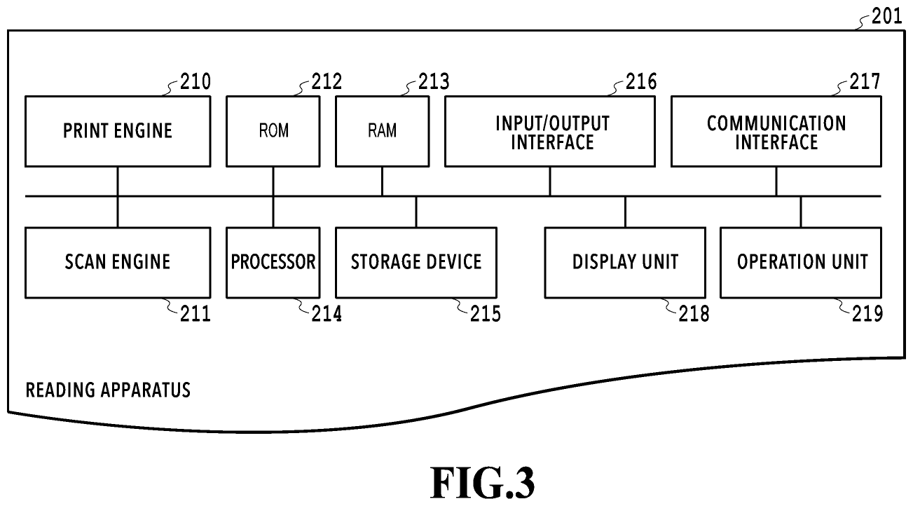

FIG. 3 is a block diagram showing an example hardware configuration of the reading apparatus 201 of the present embodiment.

The reading apparatus 201 is an example of a peripheral device. The reading apparatus 201 has a print engine 210, a scanner engine 211, ROM 212, RAM 213, a processor 214 such as a CPU, a storage device 215, an input/output interface 216, a communication interface 217, a display unit 218, and an operation unit 219. The ROM 212 is a type of computer-readable storage medium. Note that it is also possible to connect an extension option to the input/output interface 216 to extend the capability of the reading apparatus 201. The RAM 213 is used as main memory and workspace memory of the processor 214 and is where various kinds of data and a buffer for temporarily saving a print or scan job are saved. The print engine 210 performs printing based on data saved in the RAM 213. The scanner engine 211 performs scanning based on data saved in the RAM 213. The ROM 212 contains various control programs and data used by the control programs, and the processor 214 controls the units of the reading apparatus 201 according to the control programs. The communication interface 217 communicates with the information terminal 101 and the server 301 via the network. Note that the communication interface 217 transmits and receives data to and from devices on the same network and the Internet via a wireless LAN or a wired LAN using a protocol such as TCP/IP. The display unit 218 is configured including a liquid crystal display and a graphics controller and displays images and various pieces of information to a user. The operation unit 219 is a device for receiving operations for various instructions to the reading apparatus 201 from the user and is a button or the like. Note that the operation unit 219 may be integrated with the display unit 218 and configured as a touch panel.

The reading apparatus 201 includes an optical sensor for optically reading an image on an original set on the flatbed or the ADF (not shown) and stores scan image data generated by the reading by the optical sensor into the RAM 213. Also, the reading apparatus 201 transmits a scan instruction to the information terminal 101 through the communication interface 217. After that, the reading apparatus 201 receives a scan start instruction from the information terminal 101, scans an original, and transmits scan data to the information terminal 101.

### Push Scan Processing

### <Processing by the Information Terminal>

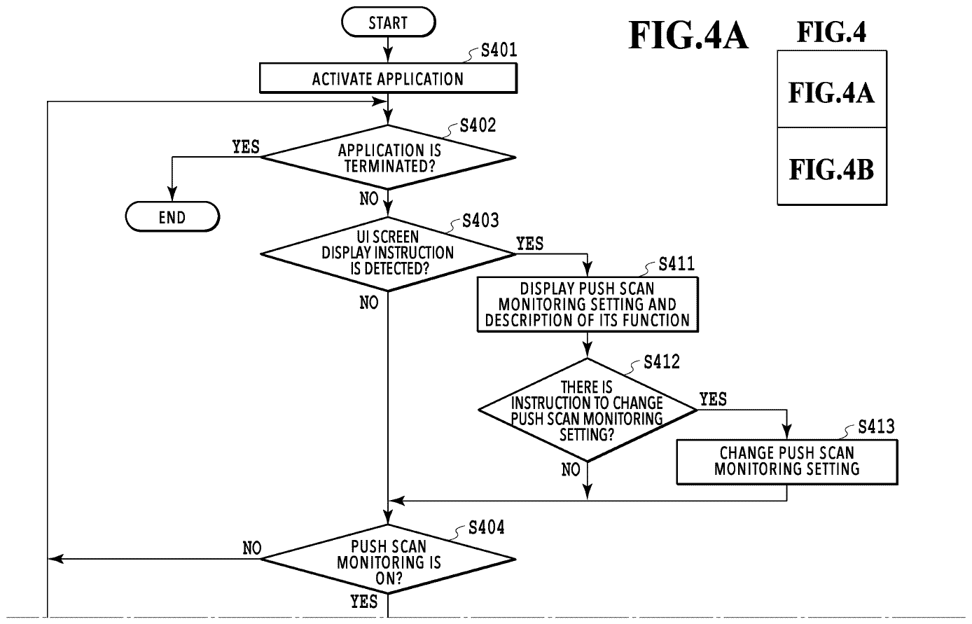

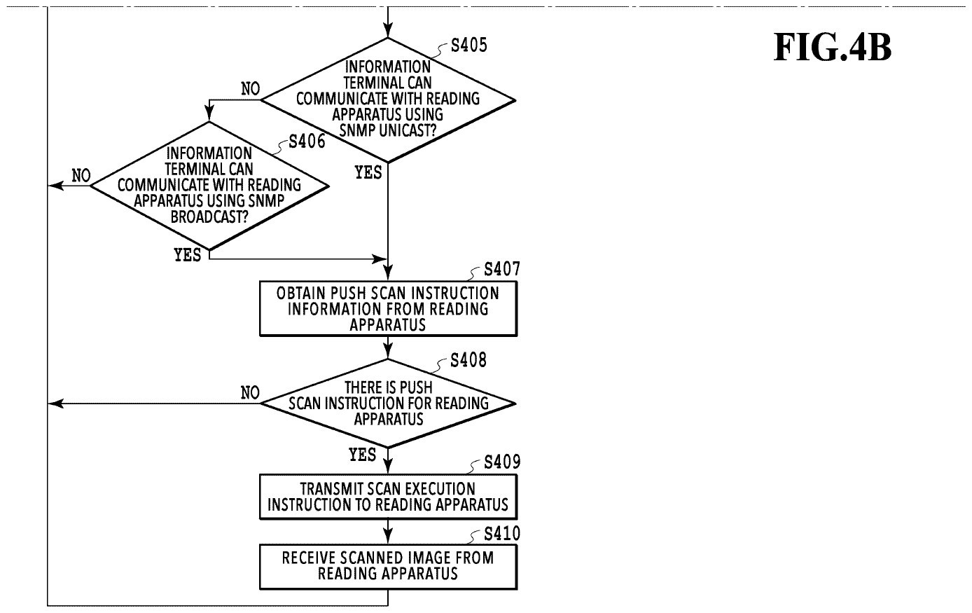

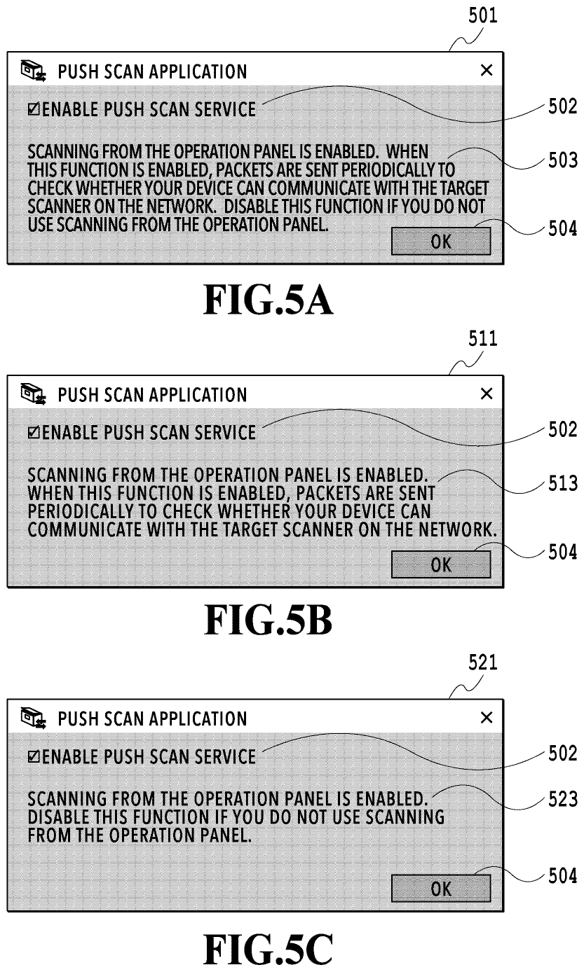

Next, push scan processing performed by the information terminal 101 of the present embodiment is described in detail with reference to FIGS. 4A to 5C. FIGS. 4A and 4B are flowcharts showing an example of push scan processing by the information terminal 101. FIGS. 5A to 5C are schematic diagrams showing example user interfaces on the information terminal 101.

Each process in this flowchart is implemented by the processor 111 by loading a program for a scan application stored in the ROM 112 into the RAM 113 and executing the program. The scan application is application software for controlling the reading apparatus 201 and is a type of scanner driver (driver software). The processing in FIGS. 4A and 4B is executed as a function of the scan application, which is single application software.

First, in S401, the processor 111 activates the scan application. For example, the OS booted by the information terminal has registered therein the scan application to be activated once the OS is started, and the registered scan application is activated once the OS is started. Note that in a case where the scan application is temporarily suspended due to the OS's process such as a user logoff or sleep, the OS resumes upon detection of a user operation on the input device 117 for a user login, resumption from sleep, or the like. After resuming, the OS resumes the scan application. Also, the OS may activate the scan application upon detection of a user operation on the input device 117. Then, in a case where the scan application is activated upon startup of the OS, the information terminal 101 does not display a user interface (UI) and runs the scan application in the background.

Next, in S402, the processor 111 determines whether to terminate the scan application. For example, the OS booted by the information terminal 101 terminates the scan application in the event where the OS shuts down. Also, the processor 111 determines to terminate the scan application upon detection of an instruction to terminate the scan application issued by the user by operating the input device 117. Note that the process in S402 is the first process to be executed in each iteration of the following processes. The processor 111 of the information terminal 101 may start the next iteration of the process in S402 after a lapse of a certain period time. If it is determined “NO” in S402, the information terminal 101 advances to S403. If it is determined “YES” in S402, the information terminal 101 ends the processing shown in the present flowchart.

Next, if it is determined “NO” in S402, in S403 the processor 111 determines whether an instruction to display a UI screen has been detected. For example, in a case where the scan application is resident in, e.g., a task tray, which is a function of an OS such as Windows, the processor 111, upon detection of a user selecting a given icon on the task tray, determines that an instruction has been issued to display a UI screen. Note that the process in S403 does not need to be performed in a case where a UI is already being displayed. If it is determined “NO” in S403, the processor 111 advances the processing to S404. If it is determined “YES” in S403, the information terminal 101 advances the processing to S411.

Next, if it is determined “NO” in S403, in S404 the processor 111 determines whether the push scan monitoring setting is turned on. For example, in the scan application, the processor 111 holds a setting value indicative of whether to perform push scan monitoring processing. The push scan monitoring processing here refers to processing to receive information from the reading apparatus 201 by polling, the information indicating that a scan instruction has been issued by an operation performed on the reading apparatus 201 end. In a case where the setting value is a value indicating to perform the push scan monitoring processing, the processor 111 determines that the push scan monitoring setting is turned on. If it is determined “YES” in S404, the processor 111 advances the processing to S405. If it is determined “NO” in S404, the processor 111 advances the processing to S402.

Next, if it is determined “YES” in S404, in S405 the processor 111 determines whether the information terminal 101 can communicate with the reading apparatus 201 using SNMP unicast. For example, the information terminal 101 holds the IP address of the reading apparatus 201 which was used in communications with the reading apparatus 201 previously in the scan application. The processor 111 determines whether the information terminal 101 can communicate with the reading apparatus 201 by transmitting an SNMP packet to that IP address and seeing if the reading apparatus 201 responds to it. Note that the information terminal 101 may hold information for identifying the target reading apparatus 201 and determine that the information terminal 101 can communicate with the reading apparatus 201 if the information for identifying the target reading apparatus 201 coincides with identification information obtained from the response packet. The identification information is information usable to perform device identification of the reading apparatus 201 and is, for example, a media access control (MAC) address, a serial number, or the like. Also, although a SNMP packet is used here as an example, a packet of a different protocol may be used. If it is determined “NO” in S405, the processor 111 advances the processing to S406. If it is determined “YES” in S405, the processor 111 advances the processing to S407.

Next, if it is determined “NO” in S405, in S406 the processor 111 determines whether the information terminal 101 can communicate with the reading apparatus 201 using SNMP broadcast. For example, in a case where the information terminal 101 cannot communicate with the reading apparatus 201 using unicast, there is a possibility that the IP address of the reading apparatus 201 has been changed from the IP address of the reading apparatus 201 held by the information terminal 101. Thus, the information terminal 101 determines whether the information terminal 101 can communicate with the reading apparatus 201 by transmitting an SNMP packet using SNMP broadcast and seeing if the reading apparatus 201 responds to it. Also, the information terminal 101 may hold information for identifying the target reading apparatus 201 and determine that the information terminal 101 can communicate with the reading apparatus 201 if the information for identifying the target reading apparatus 201 coincides with identification information obtained from the response packet. Then, the information terminal 101 determines that the IP address of the responder is the new IP address and overwrites the old IP address that it holds with the new IP address. Also, the information terminal 101 may transmit a SNMP packet with an identifier set in the SNMP community name, and the target reading apparatus 201 may respond with a SNMP packet in a case where the SNMP community name is authenticated using an authentication function. Note that there may be more than one target reading apparatus 201. Also, although SNMP broadcast is used as an example here, multicast may be used, and a packet of a different protocol may be used. For example, protocols for name resolution and service discovery may be employed, such as multicast Domain Name System (mDNS), Link-Local Multicast Name Resolution (LLMNR), or Service Location Protocol (SLP). In a case of employing a method that uses broadcast or multicast to search for the reading apparatus 201, the processor 111 transmits a packet not only to the target reading apparatus 201, but also to other devices. In other words, in the above case, the processor 111 transmits a packet also to the server 301, a switch, and the like on the same network. Upon receipt of a packet that they do not need to receive, the server 301, the switch, or the like may output a log of warning, error, or the like. For example, in a case where the SNMP community name is a name not authenticated by the authentication function, the server 301 outputs a warning log. If it is determined “YES” in S406, the processor 111 advances the processing to S407. If it is determined “NO” in S406, the processor 111 advances the processing to S402.

Next, if it is determined “YES” in S405 or if it is determined “YES” in S406, in S407 the processor 111 obtains push scan instruction information from the reading apparatus 201. The push scan instruction information includes information on whether the user has issued a scan instruction by operating the reading apparatus 201. For example, the push scan instruction information included in the payload section of Hypertext Transfer Protocol (HTTP) and Hypertext Transfer Protocol Secure (HTTPS) is obtained using unicast. The information terminal 101 and the reading apparatus 201 can communicate with each other by unicast here because it has been determined “YES” in S405 or S406 and the information terminal 101 holds the current IP address (also referred to as “connection information”) of the reading apparatus 201. Also, the information terminal 101 transmits identification information such as a user name and the name of the information terminal 101 to the reading apparatus 201, the identification information being used by the user in selecting, on the reading apparatus 201, the information terminal 101 to which to send the push scan instruction information. The reading apparatus 201 displays the received identification information, such as a user name and the name of the information terminal 101, on the panel of the reading apparatus 201. Once the user specifies the identification information on the panel, the reading apparatus 201 determines the target information terminal 101 and transmits the push scan instruction information to the specified information terminal 101. Note that the information terminal 101 may transmit the identification information such as a user name and the name of the information terminal 101 by including it in a request to obtain the push scan instruction information or by transmitting it separately. Also, although HTTP and HTTPS unicast is used here as an example, broadcast or multicast may be used, and a packet of a different protocol may be used.

Next, in S408, the processor 111 determines whether there is a push scan instruction. For example, the information terminal 101 determines that there is a push scan instruction if the information obtained in S407 includes information indicating that the user has issued a scan instruction by operating the reading apparatus 201. Alternatively, the information terminal 101 may determine that there is a push scan instruction if the information obtained in S407 includes a setting value indicative of scan execution. S407 and S408 constitute obtainment processing. If it is determined “YES” in S408, the processor 111 advances the processing to S409. If it is determined “NO” in S408, the processor 111 advances the processing to S402.

Next, if it is determined “YES” in S408, in S409 the processor 111 transmits a scan execution instruction to the reading apparatus 201. For example, the processor 111 obtains scan setting values set by the user by operating the reading apparatus 201, generates a scan job based on the scan setting values, and transmits the scan job to the reading apparatus 201. Also, the scan job may be generated using scan setting values set on the information terminal 101 end. Alternatively, the reading apparatus 201 may hold scan setting values set by the user by operating the reading apparatus 201, and the information terminal 101 may transmit only information serving as a scan execution instruction.

Next, in S410, the processor 111 receives a scanned image from the reading apparatus 201. For example, in response to the scan job received in S409, the reading apparatus 201 executes scanning according to the setting values in the scan job. Then, the information terminal 101 requests the reading apparatus 201 for image data as a scan result and receives the image data as a scan result from the reading apparatus 201. Then, the information terminal 101 saves the received scan image data as a scan file and displays the location where the file is saved on the display device 118. The information terminal 101 holds setting values such as, for example, a file name, a save location, and a data format, and saves the scan file according to the setting values. The information terminal 101 displays the location where the file is saved by activating a file display program such as the OS's file viewer. Also, the scan application may display a character string indicating the location where the file is saved on a UI along with, e.g., a message indicating that the scan file has been saved. The processor 111 then advances the processing to S402.

If it is determined “YES” in S403, in S411 the processor 111 displays a description of the push scan monitoring setting and the function of the push scan monitoring setting. For instance, the processor 111 displays a push scan setting screen 501 in FIG. 5A on the display device 118.

A push scan monitoring setting checkbox 502 is displayed in a checked (ON) state in a case where the setting value for the push scan monitoring processing held by the scan application indicates “ON” and is displayed in an unchecked (OFF) state in a case where the setting value indicates “OFF.” Also, upon detection of the user pressing the push scan monitoring setting checkbox 502, the push scan monitoring setting checkbox 502 displayed in a checked (ON) state is switched to an unchecked (OFF) state, and the setting value for the push scan monitoring processing is changed to “OFF.” Similarly, the push scan monitoring setting checkbox 502 in an unchecked (OFF) state is switched to a checked (ON) state, and the setting value for the push scan monitoring processing is changed to “ON.” A push scan monitoring function description message 503 gives a description of the push scan monitoring function. In a case where the push scan monitoring setting is turned on, the description message 503 includes a statement (also referred to as a first guidance) saying that a packet is periodically transmitted by polling to check whether it is possible to communicate with the target scanner. The description message 503 also includes a statement (also referred to as a “second guidance”) prompting the user to turn off the push scan monitoring setting in a case where they do not use the push scan service. Upon detection of pressing of an OK button 504, the information terminal 101 closes the push scan setting screen 501.

Next, in S412, the processor 111 determines whether there is an instruction to change the push scan monitoring setting. For example, the processor 111 determines that there is a change instruction upon detection of the user pressing the push scan monitoring setting checkbox 502. If it is determined “YES” in S412, the processor 111 advances the processing to S413. If it is determined “NO” in S412, the processor 111 advances the processing to S404.

Next, if it is determined “YES” in S412, in S413 the processor 111 changes the push scan monitoring setting. Specifically, if the push scan monitoring setting checkbox 502 is displayed in a checked (ON) state, the processor 111 switches the state to an unchecked (OFF) state, changing the setting value for the push scan monitoring processing to OFF. Conversely, if the push scan monitoring setting checkbox 502 is displayed in an unchecked (OFF) state, the processor 111 switches the state to a checked (ON) state, changing the setting value for the push scan monitoring processing to ON. The processor 111 then advances the processing to S404.

Note that the processes from S411 to S413 may run in parallel with the processes from S402 to S410. Specifically, with the processes from S411 to S413 omitted from the processing in FIGS. 4A and 4B and a process for iterating S411 to 413 added thereto, the processor 111 may execute these processes simultaneously using the multitasking or multithreading function of the OS.

### Processing by the Reading Apparatus

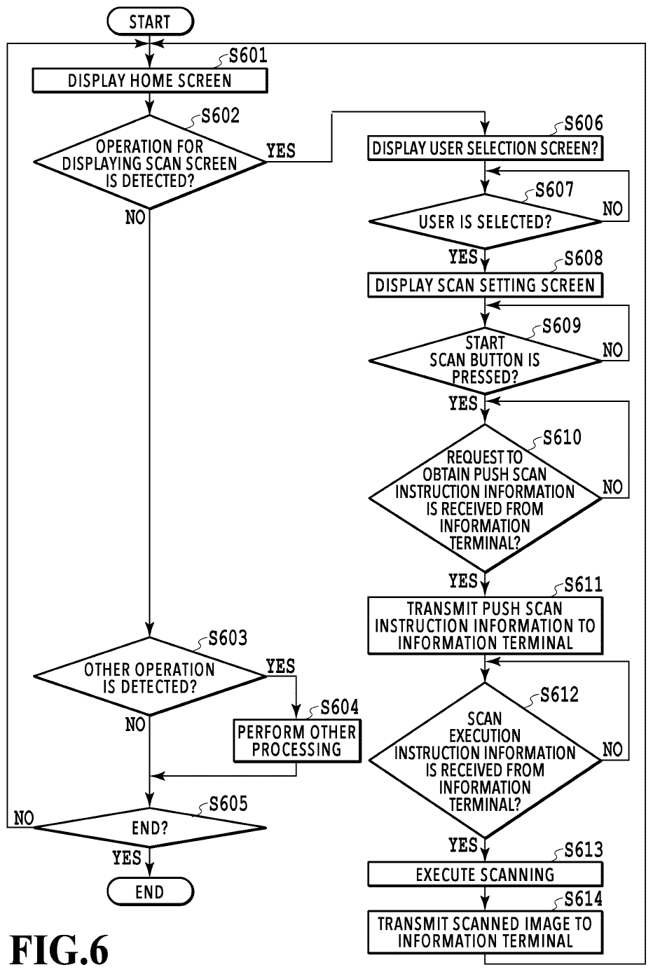

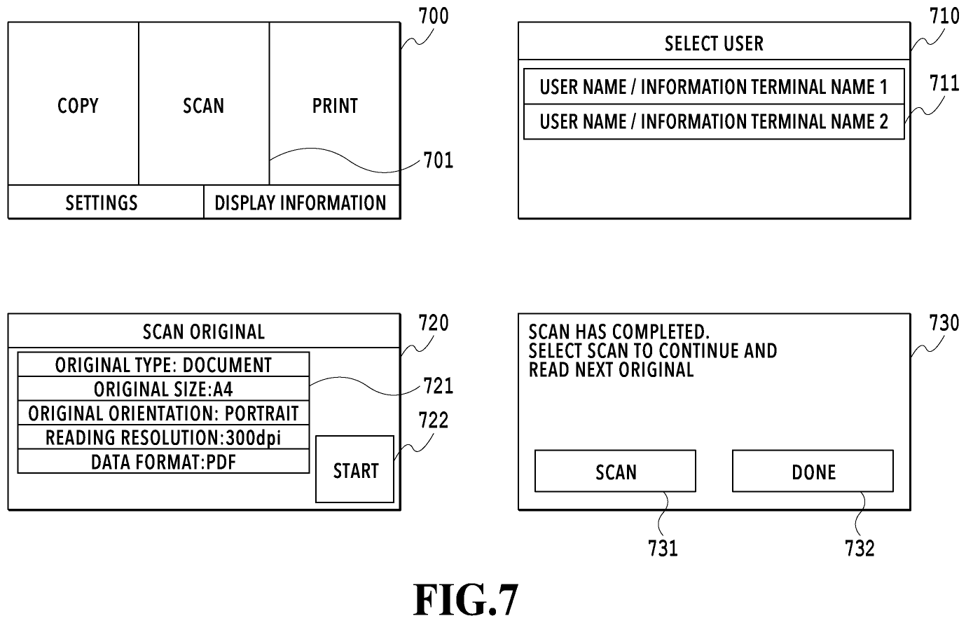

Next, with reference to FIGS. 6 to 7, a detailed description is given of a flowchart of push scan processing performed by the processor 214 of the reading apparatus 201 in the present embodiment. FIG. 6 is a flowchart showing an example of push scan processing executed by the processor 214 of the reading apparatus 201. FIG. 7 is a schematic diagram showing example user interfaces on the reading apparatus 201.

Each process shown in this flowchart is implemented by the processor 214 by loading a program stored in the ROM 212 into the RAM 213 and executing the program.

The processor 214 starts the present flowchart upon detection of the power button being pressed.

First, in S601, the processor 214 displays a home screen 700 in FIG. 9 on the display unit 218. Note that the operation unit 219 is integrated with the display unit 218 and configured as a touch panel in the present embodiment.

Next, in S602, the processor 214 determines whether a scan screen display instruction has been detected. The processor 214 processor 214 determines that a scan screen display instruction has been detected by detecting pressing of a Scan button 701 on the home screen 700. If it is determined “NO” in S602, the processor 214 advances the processing to S603. If it is determined “YES” in S602, the processor 214 advances the processing to S606.

Next, if it is determined “NO” in S602, in S603 the processor 214 determines whether other operation has been detected. The processor 214 determines whether other operation has been detected by detecting pressing of a button other than the Scan button 701 on the home screen 700. Examples of the button other than the Scan button 701 on the home screen 700 include a Copy button, a Print button, a Device Settings button, and a Display Device Information button. If it is determined “YES” in S603, the processor 214 advances the processing to S604. If it is determined “NO” in S603, the processor 214 advances the processing to S605.

Next, if it is determined “YES” in S603, in S604 the processor 214 executes the other processing. Examples of the other processing include copy processing, print processing, device settings processing, and device information display processing. For instance, if the Copy button is pressed in S603, the other processing is processing to display a copy screen, have the user configure copy settings, and then execute copying. After that, the processor 214 advances the processing to S605.

Next, in S605, the processor 214 determines whether to end the processing shown in the present flowchart. For example, the processor 214 determines to end the present flowchart upon detection of pressing of the power button. If it is determined “NO” in S605, the processor 214 advances the processing to S601. If it is determined “YES” in S605, the processor 214 ends the present flowchart.

If it is determined “YES” in S602, in S606 the processor 214 displays a user selection screen 710. The reading apparatus 201 has received identification information such as the user name or the name of the information terminal 101 from the information terminal 101 in S407, the identification information being used by the user in selecting, on the reading apparatus 201, the information terminal 101 to which to send push scan instruction information. Thus, the received identification information is displayed on the user selection screen 710 as identification information 711.

Next, in S607, the processor 214 determines whether a user has been selected. For example, the processor 214 determines that the user has been selected by detecting the user pressing the identification information 711 displayed in S606 and thereby determining the target information terminal 101. If it is determined “YES” in S607, the processor 214 advances the processing to S608. If it is determined “NO” in S607, the processor 214 executes S607 again.

Next, if it is determined “YES” in S607, in S608 the processor 214 displays a scan settings screen 720. Setting items 721 are displayed on the scan settings screen 720, such as, for example, the type of the original (such as document or photograph), the size of the original, the orientation of the original, the reading resolution, and the data format of the scan image file. Note that the setting items can be changed. Examples of the file format selectable as the data format include JPEG, PNG, and PDF. Note that the screen may be designed so that the compression ratio of JPEG or PDF and the like (not shown) can be set or so that other setting items can be set.

Next, in S609, the processor 214 determines whether a Start Scan button 722 has been pressed. For example, the processor 214 determines that the Start Scan button 722 has been pressed by detecting the user pressing the Start Scan button 722 displayed in S608. If it is determined “YES” in S609, the processor 214 advances the processing to S610. If it is determined “NO” in S609, the processor 214 executes S609 again.

Next, if it is determined “YES” in S609, in S610 the processor 214 determines whether a request to obtain push scan instruction information has been received from the information terminal 101. The processor 214 determines “YES” if a request to obtain push scan instruction information has been received from the information terminal 101 in S407. If it is determined “YES” in S610, the processor 214 advances the processing to S611. If it is determined “NO” in S610, the processor 214 executes S610 again.

Next, if it is determined “YES” in S610, in S611 the processor 214 transmits push scan instruction information to the information terminal 101. Note that the processor 214 may transmit scan setting values along with the push scan instruction information. The scan setting values are values set on the scan settings screen 720 and include, for example, the type of the original (such as document or photograph), the size of the original, the orientation of the original, the reading resolution, and the data format of the scan image file.

Next, in S612, the processor 214 determines whether scan execution instruction information has been received from the information terminal 101. For example, the processor 214 determines “YES” if a scan job has been received from the information terminal 101 in S409. If it is determined “YES” in S612, the processor 214 advances the processing to S613. If it is determined “NO” in S612, the processor 214 executes S612 again.

Next, if it is determined “YES” in S612, in S613 the processor 214 executes scanning. For example, the processor 214 executes the scanning according to the setting values in the scan job received in S612.

Next, in S614, the processor 214 transmits the scanned image to the information terminal 101. The processor 214 transmits scan image data acquired as a result of the scanning in response to a scan image data request from the information terminal 101. For example, the processor 214 displays a reading completion screen 730 after transmitting the scan image data. A message is displayed on the reading completion screen 730, checking whether to continue and read the next original. The processor 214 executes scanning of the next original by detecting the user pressing a Scan button 731 on the reading completion screen 730 to read the next original. Then, the processor 214 determines that the user has finished scanning all the originals by detecting pressing of a Done button 732 and then transmits a notification to the information terminal 101, stating that all the originals have been scanned. Then, the processor 214 advances the processing to S601. Although the processing advances to S601 to display the home screen 700 after the completion of scanning in this example, a different screen may be displayed. For example, the processor 214 may advance the processing to S606 to display the user selection screen 710 or to S608 to display the scan settings screen 720.

In place of the push scan setting screen 501 shown in FIG. 5A, the processor 111 may display a push scan setting screen 511 shown in FIG. 5B or a push scan setting screen 521 shown in FIG. 5C. A message 513 displayed on the push scan setting screen 511 omits part of the message 503 displayed on the push scan setting screen 501. A message 523 displayed on the push scan setting screen 521 omits other part of the message 503 displayed on the push scan setting screen 501. Specifically, the message 503 includes “Scanning from the operation panel is enabled.” The message 503 also includes “When this function is enabled, packets are periodically sent to check whether your device can communicate with the target scanner on the network” (a first guidance). The message 503 further includes “Disable this function if you do not use scanning from the operation panel” (a second guidance). The message 513 is the message 503 without the second guidance, and the message 523 is the message 503 without the first guidance. In this way, the processor 111 performs display control to display one or both of the first guidance and the second guidance on the push scan setting screen.

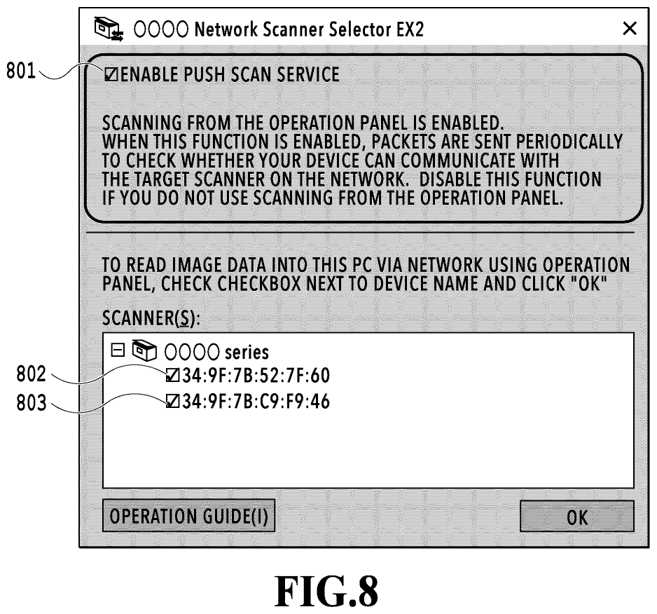

As shown in FIG. 8, more than one reading apparatus may be supported. In the example in FIG. 8, two reading apparatuses are supported. Unchecking a checkbox 801 disables polling of the two reading apparatuses collectively. Also, checking the checkboxes 801, 802, and 803 enables polling of the two reading apparatuses. Further, checking the checkboxes 801 and 802 and unchecking the checkbox 803 enables polling of only the first reading apparatus. Further, checking the checkboxes 801 and 803 and unchecking the checkbox 802 enables polling of only the second reading apparatus. In other words, polling of the two reading apparatuses can be turned on and off individually using the checkboxes 802 and 803 with the checkbox 801 checked.

According to the present disclosure, a polling setting for a push scan service is easier to understand, and in a case where the push scan setting is turned off, no warning log is outputted from a switch or the server.

Note that the various kinds of control in the processing shown in FIGS. 4A and 4B that are described as being performed by the processor 111 may be performed by a single piece of hardware or a plurality of pieces of hardware (e.g., a plurality of processors or circuits) sharing the processing to perform overall control of the apparatus. Similarly, the various kinds of control in the processing shown in FIG. 6 that are described as being performed by the processor 214 may be performed by a single piece of hardware or a plurality of pieces of hardware (e.g., a plurality of processors or circuits) sharing the processing to perform overall control of the apparatus.

Also, although the present disclosure has been described in detail based on its preferred embodiments, the present disclosure is not limited to these particular embodiments and also includes various other modes without departing from the gist of the present disclosure. Further, each embodiment described above merely demonstrates one embodiment of the present disclosure, and the embodiments can be combined as needed.

Also, although the present disclosure is applied to a reading apparatus in the example described in the embodiments, the present disclosure is not limited to this example and can be applied to any apparatus that is polled by an information processing apparatus for pseudo-push communications from the apparatus. Specifically, the present disclosure can be applied to a personal computer, a personal digital assistant (PDA), a mobile phone terminal, a portable image viewer, a printer device with a display, a digital photo frame, a music player, a game console, an electric book reader, and the like.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present disclosure makes it easier to understand a polling setting for a push scan service and makes it easier for a user to change the polling setting.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-220269, filed Dec. 16, 2024, which is hereby incorporated by reference herein in its entirety.

What is claimed is:

1. An information processing apparatus capable of communicating with a reading apparatus, the information processing apparatus comprising at least one memory and at least one processor which function as:
a processing unit configured to periodically perform obtainment processing to obtain first information from the reading apparatus, the first information indicating whether an operation to instruct execution of scanning has been performed on the reading apparatus;
a setting unit configured to set to enable or disable a particular function that allows the information processing apparatus to obtain, from the reading apparatus, a scan result acquired by the reading apparatus by the execution of the scanning, the particular function being based on the operation performed on the reading apparatus to instruct execution of scanning; and
a display control unit configured to perform control to display at least one of a first guidance and a second guidance, the first guidance pertaining to periodical execution of the obtainment processing by the processing unit in a case where the setting unit enables the particular function and the second guidance pertaining to disabling the particular function.

2. The information processing apparatus according to claim 1, wherein
the second guidance prompts a user to disable the particular function in a case where the user does not use the particular function.

3. The information processing apparatus according to claim 1, wherein
the display control unit performs control to display the first guidance.

4. The information processing apparatus according to claim 1, wherein
the display control unit performs control to display the second guidance.

5. The information processing apparatus according to claim 1, wherein
the display control unit performs control to display the first guidance and the second guidance.

6. The information processing apparatus according to claim 1, wherein
the obtainment processing by the processing unit is periodically performed in a case where the setting unit enables the particular function, and
the obtainment processing by the processing unit is not performed in a case where the setting unit disables the particular function.

7. The information processing apparatus according to claim 1, comprising the processing unit, the setting unit, and the display control unit as functions of particular application software.

8. The information processing apparatus according to claim 7, wherein
the application software is single application software.

9. The information processing apparatus according to claim 7, wherein
the application software is software for controlling the reading apparatus.

10. The information processing apparatus according to claim 1, wherein
the display control unit displays one or both of the first guidance and the second guidance on a screen for setting to enable or disable the particular function.

11. The information processing apparatus according to claim 1, wherein
the setting unit sets to enable or disable the particular function for a plurality of the reading apparatuses.

12. The information processing apparatus according to claim 1, wherein
the at least one memory and the at least one processor further function as a unit configured to, in a case where it is determined, before the processing unit obtains the first information, that the information processing apparatus is unable to communicate with the reading apparatus using unicast, make a search for the reading apparatus using broadcast or multicast and obtain the first information from the reading apparatus using connection information acquired by the search.

13. The information processing apparatus according to claim 1, wherein
the processing unit obtains the first information using a protocol with an authentication function.

14. The information processing apparatus according to claim 1, wherein
the processing unit obtains the first information using SNMP.

15. The information processing apparatus according to claim 1, wherein
the processing unit obtains the first information by setting an SNMP community name.

16. The information processing apparatus according to claim 1, wherein
the processing unit obtains the first information using USB connection.

17. The information processing apparatus according to claim 1, wherein
the setting unit sets to enable or disable the particular function for a plurality of the reading apparatus individually or collectively.

18. A display control method performed by an information processing apparatus capable of communicating with a reading apparatus, the method comprising:
periodically performing obtainment processing to obtain first information from the reading apparatus, the first information indicating whether an operation to instruct execution of scanning has been performed on the reading apparatus;
setting to enable or disable a particular function that allows the information processing apparatus to obtain, from the reading apparatus, a scan result acquired by the reading apparatus by the execution of the scanning, the particular function being based on the operation performed on the reading apparatus to instruct execution of scanning; and
performing control to display at least one of a first guidance and a second guidance, the first guidance pertaining to periodical execution of the obtainment processing by the processing unit in a case where the particular function is enabled in the setting and the second guidance pertaining to disabling the particular function.

19. A non-transitory computer-readable storage medium storing a program for causing at least one memory and at least one processor to function as:
a processing unit configured to periodically perform obtainment processing to obtain first information from the reading apparatus, the first information indicating whether an operation to instruct execution of scanning has been performed on the reading apparatus;
a setting unit configured to set to enable or disable a particular function that allows the information processing apparatus to obtain, from the reading apparatus, a scan result acquired by the reading apparatus by the execution of the scanning, the particular function being based on the operation performed on the reading apparatus to instruct execution of scanning; and
a display control unit configured to perform control to display at least one of a first guidance and a second guidance, the first guidance pertaining to periodical execution of the obtainment processing by the processing unit in a case where the setting unit enables the particular function and the second guidance pertaining to disabling the particular function.
